(19) United States
(12) Patent Application Publication
(10) Pub. No.: US 2015/0057820 A1
(43) Pub. Date: Feb. 26, 2015

(54) BUILDING ENERGY MANAGEMENT OPTIMIZATION

(71) Applicant: FUJITSU LIMITED, Kawasaki-shi (JP)

(72) Inventors: Mahdi KEFAYATI, Austin, TX (US); Wei-Peng CHEN, Fremont, CA (US)

(73) Assignee: FUJITSU LIMITED, Kawasaki-shi (JP)

(21) Appl. No.: 13/972,756

(22) Filed: Aug. 21, 2013

(51) Int. Cl. G06Q 50/06

(52) U.S. Cl. CPC G06Q 50/06
USPC 700/291

(57) ABSTRACT

A method of managing energy consumption of a building may include determining a current state associated with energy consumption of a building and determining exogenous factors that relate to energy consumption of the building. The method may also include performing an energy consumption and cost optimization based on the current state, the exogenous factors, and an energy consumption rate structure to generate a desired energy consumption projection for the building over a period of time. The method may further include controlling one or more systems of the building to direct energy consumption of the building according to the desired energy consumption projection.

### FIELD

The embodiments discussed herein are related to building energy management optimization.

### BACKGROUND

Improving energy efficiency of a building may help reduce the costs associated with maintaining and using the building and may also help reduce the environmental impact of the building. Further, many utility companies vary the cost of energy consumption (e.g., electricity use) during different times (e.g., during peak consumption hours versus off-peak consumption hours) such that the cost of energy used by the building may vary according to the time of day and/or year even if the amount of energy being used is relatively constant. Additionally, utility companies may encourage participation in demand response (DR) events where customers may receive incentives for reducing energy consumption during a scheduled DR event.

Traditional energy management systems may be inadequate in effectively managing cost and energy consumption with respect to varying energy costs and DR events. For example, in some instances, participation in a DR event based on traditional energy management systems and processes may result in overall increased energy consumption by a building due to increased energy use after the DR event to place the building in a non-DR event state.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method of managing energy consumption of a building may include determining a current state associated with energy consumption of a building and determining exogenous factors that relate to energy consumption of the building. The method may also include performing an energy consumption and cost optimization based on the current state, the exogenous factors, and an energy consumption rate structure to generate a desired energy consumption projection for the building over a period of time. The method may further include controlling one or more systems of the building according to the desired energy consumption projection.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example system configured to manage energy consumption of a building; and

FIG. 2 illustrates a flowchart of an example method of building energy management optimization.

### DESCRIPTION OF EMBODIMENTS

Improving energy efficiency of buildings is a growing interest in today's world. Improving energy efficiency may include reducing both energy costs and environmental impact. To improve energy efficiency, the control of systems within buildings that consume energy is increasingly automated and optimized in a manner to reduce energy consumption of the buildings. However, exogenous factors that affect energy consumption may constantly change such that maintaining a certain optimization trajectory may be difficult. Exogenous factors may be any factors that may not be controlled by an energy management system and may include weather conditions, building occupancy, electricity consumption from electrical outlets, dynamic electricity price, and the like.

Additionally, utility companies are increasingly varying their energy usage rates to account for demand, such as charging more during peak usage hours than off-peak usage hours, as well as encouraging customers to participate in demand response (DR) programs that provide economic incentives for customers to reduce energy consumption at certain times. As such, determining cost benefits of energy use reduction may also be difficult because of constantly varying rate structures.

Accordingly, as described in further detail below, in some embodiments of the present disclosure, a building energy management system (BEMS) may be configured to manage energy consumption of a building using a dynamic optimization scheme that considers energy consumption of controllable systems (e.g., lighting, smart appliances, landscape lighting, heating and air conditioning systems, etc.), exogenous factors that affect energy consumption of the building (e.g., weather, building occupancy, etc.), as well as the effects of participating in a demand response event if a demand response event is requested. Additionally, the BEMS may be configured to perform regular updates of the above-mentioned elements to adjust the optimization performed by the optimization scheme such that the BEMS may dynamically adjust the optimization and energy consumption of the building.

Embodiments of the present disclosure will be explained with reference to the accompanying drawings.

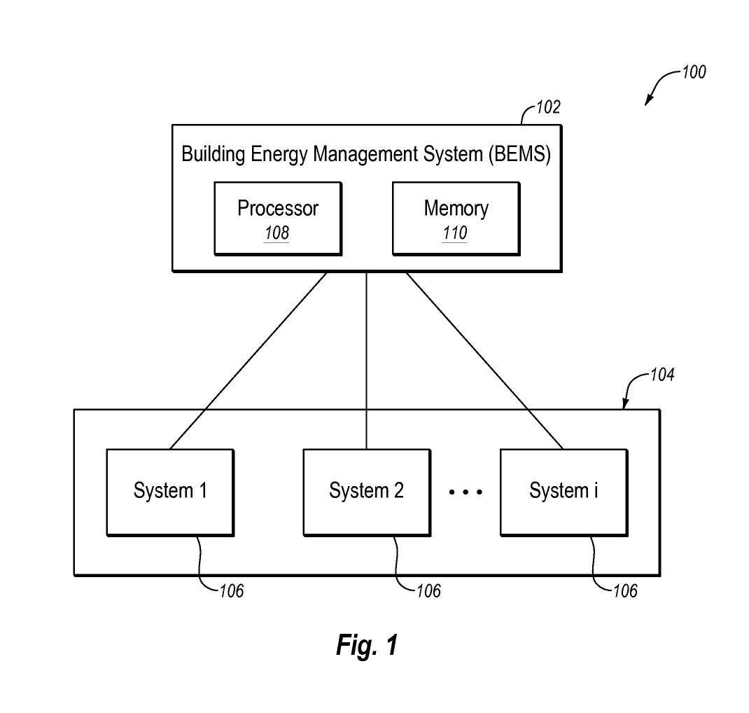

FIG. 1 illustrates an example system 100 configured to manage energy consumption of a building 104, arranged in accordance with at least one embodiment described herein. The system 100 may include a BEMS 102 that may be configured to manage energy consumption of the building 104. In some embodiments, the building 104 may include different systems 106 that may consume energy. For example, the systems 106 may include any one or more of a heating, ventilation, and air-conditioning (HVAC) system, a lighting system, a battery backup system, a generator, an electric vehicle charging station, landscaping systems (e.g., fountains, outdoor lighting, etc.), water heaters, vending machines, refrigerators, ovens, freezers, or any other system that may consume energy.

The systems 106 may be considered as systems with memory or memoryless systems. A system 106 may be considered as a system with memory where current or future energy consumption of the system 106 may be based on past behavior of the system 106 and/or the current state of the system 106. For example, prior energy consumption of a water heater may set the temperature in the water heater at a certain level, which may affect the energy consumption of the water heater in the future to maintain or set the temperature of the water at a certain level. A system 106 may be considered a memoryless system when the current energy consumption of the system 106 may not be affected by previous uses of the system 106. For example, a lighting system may be a memoryless system because prior use of the lights may not affect current or future energy consumption.

Additionally, in some embodiments, some systems 106 that may be considered systems with memory or memoryless systems may be classified individually as discussed in detail below instead of being included in the general categories of systems with memory or memoryless systems. For example, a system 106 that includes an HVAC system may be individually classified and may also be considered a system with memory due to past use of the HVAC system affecting temperatures within the building 104, which may in turn affect future energy consumption of the HVAC system. Additionally, a system 106 that includes a battery system may be individually classified even though the battery system may also be considered a system with memory due to the various states of charge of the battery system. Further, a system 106 that includes a generator system may also be individually classified even though the generator system may have memory or be a memoryless system depending on the generator system.

The BEMS 102 may include a processor 108 and memory 110. The processor 108 may be any suitable special purpose or general purpose computer including various computer hardware or software modules, as discussed in greater detail below.

The memory 110 may include computer-readable media for carrying or having computer-executable instructions or data structures stored thereon. Such computer-readable media may be any available media that may be accessed by a general purpose or special purpose computer. By way of example, and not limitation, such computer-readable media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media. Computer-executable instructions may include, for example, instructions and data which cause the processor 108 to perform a certain function or group of functions.

In some embodiments, the BEMS 102 may classify the systems 106 as memoryless systems, systems with memory, HVAC systems (which may have memory, but may also be classified individually), battery systems (which may also have memory, but may also be classified individually), and generator systems (which may have memory or may be memoryless depending on the generator system, but may also be classified individually). As discussed in detail below, the classifications of the systems 106 may be used by the BEMS 102 to model the different systems 106 while performing the optimization scheme to improve energy efficiency and reduce costs.

The BEMS 102 may be configured to control the systems 106 such that the BEMS 102 may control the energy consumption of one or more of the systems 106 either individually or collectively. In some embodiments, the BEMS 102 may be configured to perform a learning process with respect to the building 104 and different settings of the systems 106 (e.g., temperature settings associated with an HVAC system) while various exogenous factors (e.g., weather, occupancy, time of year, time of day, etc.) that may affect energy consumption of the systems 106 are also present. The BEMS 102 may also track the occurrence of various exogenous factors during the learning process such that the BEMS 102 may predict future instances of the various exogenous factors. Accordingly, the BEMS 102 may be able to estimate future energy consumption at different settings during the presence of exogenous factors based on the results of the learning process.

For example, the BEMS 102 may track occupancy of the building 104 throughout days, months, and years. The BEMS 102 may also be configured to track energy consumption of the building 104 based on the different occupancy levels of the building 104. Accordingly, the BEMS 102 may be configured to predict future occupancy levels of the building 104 as well as their effect on energy consumption of the building 104.

The BEMS 102 may also be configured to determine a current state associated with energy consumption of the systems 106 (referred to also simply as a “current state”) as well as exogenous factors (both current and predicted) that may affect the energy consumption of the building 104 and/or one or more of the systems 106. The BEMS 102 may also be configured to determine the cost of energy consumption related to the current state and the exogenous factors at a given point in time based on a utility rate schedule that indicates the cost of energy use at certain times of day, week, month, year, or the like.

The current state associated with energy consumption of the systems 106 may include current energy consumption of the systems 106, past energy consumption of systems 106 considered as systems with memory, individual states of the systems 106 (e.g., temperatures controlled by certain systems 106, battery charge level of a battery system, whether a light system is on or off, whether a landscape fountain is on or off, etc.), and the like. Some exogenous factors that may affect the energy consumption and/or generation of the building 104 may include weather conditions such as temperature outside of the building 104, cloud cover/sunlight, humidity, rain, wind, sleet, hail, snow, or other applicable weather conditions, occupancy of the building 104, on-site renewable energy generation (e.g., solar, wind), etc.

Based on the current state and the exogenous factors, the BEMS 102 may be configured to perform an optimization scheme to improve the energy efficiency of the building 104, as well as to improve cost savings associated with operating the building 104. In some embodiments, the optimization scheme may be performed by generating and solving a Model Predictive Control (MPC) problem, as detailed below.

For example, based on the current state, current exogenous factors, predicted exogenous factors, and predicted energy consumption—which, in some embodiments, may be determined based on the learning process—the BEMS 102 may generate and solve an MPC problem to determine which settings to use for the systems 106 to improve energy and cost efficiency. In some embodiments, the BEMS 102 may consider demand response events and utility rates while performing the optimization. The BEMS 102 may also be configured to determine the states of the systems 106 and the exogenous factors on a regular basis such that the BEMS 102 may dynamically update the optimization based on changing conditions that may not necessarily follow the predicted conditions.

As indicated above, in some embodiments, the optimization may be performed by solving an MPC problem. In some embodiments, the MPC problem may be configured to determine a minimum cost over a given horizon of operation of the building 104 and the systems 106. In some embodiments, the MPC problem may be modeled as follows using the following nomenclature which is explained in detail below:
τ current time index
t time index in the optimization problem
eₜ energy consumption of the building at time t
pₜ^{e} energy price at time t
p^{d}, p′^{d} demand charge coefficients
pₜ^{EDR} marginal energy reward of demand response
pₜ^{CDR} marginal capacity reward of demand response
w^{t} exogenous variables
eₜ^{UL} energy consumption by uncontrollable systems
eₜ^{UBL} utility baseline energy consumption
eₜ^{DR} amount of promised response for a demand response
eₜ^{ML} energy consumption of memoryless systems
eₜ^{MEM} energy consumption of systems with memory (e.g., refrigerators)
eₜ^{HVAC} energy consumption of the HVAC system
eₜ^{BAT} energy consumption/generation by battery system
eₜ^{GEN} energy consumption/generation by reliable generators (e.g., gas-powered generators)
eₜ^{UGEN} energy consumption/generation by intermittent generators (e.g., wind or solar generators)
uₜ^{ML} control signal for memoryless systems
uₜ^{MEM} control signal for systems with memory
uₜ^{HVAC} control signal for HVAC system (e.g., temperature set point)
uₜ^{BAT} control signal for battery systems
uₜ^{GEN} control signal for reliable generators
sₜ^{G} global state variables shared among systems
sₜ^{ML} state variable for memoryless systems
sₜ^{MEM} state variable for systems with memory
sₜ^{HVAC} state variable for HVAC system
sₜ^{BAT} state variable for battery systems
gₜ^{ML}(uₜ^{ML}, wₜ) energy consumption of plug-in systems
gₜ^{MEM}(uₜ^{MEM}, wₜ, sₜ^{MEM}) energy consumption of loads with memory
gₜ^{HVAC}(uₜ^{HVAC}, sₜ^{HVAC}, wₜ) energy consumption of HVAC system
gₜ^{BAT}(uₜ^{BAT}, w^{t}) energy consumption/generation by battery system
gₜ^{GEN}(uₜ^{GEN}, wₜ) energy generation by generator systems (reliable and intermittent)
C^{GEN}(eₜ^{GEN}, sₜ^{G}, wₜ) cost of energy generation
C^{PRI(•)} prioritization term in the cost function

Using the above-recited nomenclature, the optimization problem may be formulated using the following expressions and constraints, which are numbered and referred to as “Equations” to ease the explanation:

$$\begin{matrix}\begin{matrix} {u}_{τ}^{* MPC} ( {\hat{s}}_{τ} , w ) = arg {min}_{u} {\sum }_{t} {p}_{t}^{e} {e}_{t} + D ( {p}^{d} , {e}_{t} , {s}_{t}^{G} ) \\ + {R}^{D} ( {e}_{t} , {s}_{t}^{G} , {e}_{t}^{UBL} , {e}_{t}^{DR} ) + {C}^{GEN} ( {e}_{t}^{GEN} , {s}_{t}^{G} , {w}_{t} ) \\ + {C}^{PRI} ( {e}_{t}^{ML} , {e}_{t}^{MEM} , {e}_{t}^{BAT} , {w}_{t} )\end{matrix} & ( 1 ) \\ [ {s}^{G} , {s}^{ML} , {s}^{MEM} , {s}^{BAT} {S}^{HVAC} ] = {\hat{s}}_{τ} & ( 2 ) \\ {s}_{t + 1}^{G} = {f}_{t}^{G} ( {w}_{t} , {s}_{t}^{G} ) & ( 3 ) \\ {e}_{t} = {1}^{T} {e}_{t}^{UL} + {1}^{T} {e}_{t}^{ML} + {1}^{T} {e}_{t}^{MEM} + {1}^{T} {e}_{t}^{HVAC} + {1}^{T} {e}_{t}^{BAT} + {1}^{T} {e}_{t}^{GEN} + {1}^{T} {e}_{t}^{UGEN} & ( 4 ) \\ {e}_{t}^{ML} = {g}_{t}^{ML} ( {u}_{t}^{ML} , {w}_{t} ) & ( 5 ) \\ {u}_{t}^{ML} ∈ {U}_{t}^{ML} ( {w}_{t} ) & ( 6 ) \\ {s}_{t + 1}^{MEM} = {f}_{t}^{MEM} ( {u}_{t}^{MEM} , {s}_{t}^{MEM} , {s}_{t}^{G} , {w}_{t} ) & ( 7 ) \\ {e}_{t}^{MEM} = {g}_{t}^{MEM} ( {u}_{t}^{MEM} , {s}_{t}^{MEM} , {s}_{t}^{G} , {w}_{t} ) & ( 8 ) \\ {s}_{t}^{MEM} ∈ {S}_{t}^{MEM} ( {w}_{t} ) , & ( 9 ) \\ {u}_{t}^{MEM} ∈ {U}_{t}^{MEM} ( {w}_{t} ) & ( 10 ) \\ {s}_{t + 1}^{BAT} = {f}_{t}^{BAT} ( {u}_{t}^{BAT} , {s}_{t}^{BAT} , {w}_{t} ) & ( 11 ) \\ {e}_{t}^{BAT} = {g}_{t}^{BAT} ( {u}_{t}^{BAT} , {s}_{t}^{BAT} , {w}_{t} ) = {u}_{t}^{BAT} & ( 12 ) \\ {\underline{s}}_{t}^{BAT} \leq {s}_{t}^{BAT} \leq {s}_{t}^{- BAT} & ( 13 ) \\ {\underline{u}}_{t}^{BAT} \leq {u}_{t}^{BAT} \leq {u}_{t}^{- BAT} & ( 14 ) \\ {s}_{t + 1}^{HVAC} = {f}_{t}^{HVAC} ( {u}_{t}^{HVAC} , {s}_{t}^{HVAC} , {s}_{t}^{G} , {w}_{t} ) & ( 15 ) \\ {e}_{t}^{HVAC} = {g}_{t}^{HVAC} ( {u}_{t}^{HVAC} , {s}_{t}^{HVAC} , {s}_{t}^{G} , {w}_{t} ) & ( 16 ) \\ {\underline{s}}_{t}^{HVAC} \leq {s}_{t}^{HVAC} \leq {s}_{t}^{- HVAC} & ( 17 ) \\ {\underline{u}}_{t}^{HVAC} \leq {u}_{t}^{HVAC} \leq {u}_{t}^{- HVAC} & ( 18 ) \\ {u}_{t}^{GEN} ∈ {u}_{t}^{GEN} ( {w}_{t} ) & ( 19 ) \\ {e}_{t}^{GEN} = {u}_{t}^{GEN} & ( 20 )\end{matrix}$$

In the above formulation, decisions and outputs may constitute decision variables that may be used by the BEMS 102 to seek a desired energy consumption path for the building 104 by incorporating the state, control, and output variables described above to reduce, and in some instances, minimize an overall cost of operation of the building 104 within constraints listed above. The desired energy consumption path may be determined by Equation (1) and is denoted above by the expression: u_{τ}*^{MPC}(ŝ_{τ}, w), which may represent the above-recited control signals (u_{τ}*^{MPC}) for the systems 106 of the building 104 based on the current state variables (ŝ_{τ}) and exogenous factors (w) that may achieve the desired energy consumption path of the building 104.

In the above formulation, constraints found in Equations (3), (7), (11), and (15) may be used to enforce a consistent evolution of the state variables as they change over time for models that may be used for the different systems 106. Additionally, constraints found in Equations (5), (8), (12), (16), and (20) may be used to enforce relationships between the states of certain systems 106 and their energy consumption. The above-listed constraints may be referred to as system “dynamics” constraints.

The above formulation may also include another class of constraints that may be used to enforce a desired and valid trajectory for some of the systems 106. For example, equations (13) and (14) may include constraints associated with battery systems such that the controls and states used may not violate physical constraints of the battery systems. Additionally, the constraints included in Equations (17) and (18) may be used to keep temperatures in one or more zones of the building 104 within desired ranges. Further, the formulation may also include “auxiliary” constraints such as the one included in Equation (4), which may define auxiliary decision variables.

Some of the terms included in Equation (1) may be referred to as a cost function, and in the current example may include the following terms:
1. Running cost of electricity based on a given time of use rate, as represented by pₜ^{e}, and energy consumption at the given time, as represented by eₜ;
2. A demand charge, as represented by D(p^{d}, eₜ, sₜ^{G});
3. A demand response reward/penalty, as represented by R^{D}(eₜ, sₜ^{G}, eₜ^{UBL}, eₜ^{DR});
4. On-site electricity generation cost, as represented by C^{GEN}(eₜ^{GEN}, sₜ^{G}, wₜ); and
5. A resource prioritization term, as represented by C^{PRI}(eₜ^{ML}, eₜ^{MEM}, eₜ^{RAT}, wₜ).

The running cost of electricity may be determined by simply multiplying pₜ^{e} and eₜ.

The demand charge may be calculated as a combination of different charges that may be associated with a given window of energy consumption (e.g., on-peak or off-peak hours). In some embodiments, different time windows may be denoted as a set of time windows by the following expression {τₖ, ∀k ∈ I^{d}} where τₖ may represent a particular time interval for a particular rate structure and I^{d} may indicate a set of different time intervals of the particular rate structure. The demand charge D(p^{d}, eₜ, sₜ^{G}) may be determined starting with the following equation as a basis:
(21)

In Equation (21), p₀^{d} may represent a base demand rate charge, pₖ^{d} may represent an additional demand charge rate for the particular time interval τₖ and where “x” represents a value in the brackets (∥ ∥) of the above expression (e.g., ∥xₜ∥_{∞}^{T} may represent ∥eₜ∥_{∞}⁹⁶ ^{ₖ}):

∥xₜ∥_{∞}^{T}=max{xₜ|t ∈ T} (22)

By way of example, a demand charge rate structure may include an off-peak time interval, a part-peak time interval and a peak time interval. Accordingly, in some embodiments I^{d} may be represented by the following equation:

I^{d}={0,1,2}={off−peak, part−peak, peak} (23)

Using the example of Equation (23), Equation (21) may be reduced to the following equation:

p_{off-peak}^{d}∥eₜ∥_{∞}^{off-peak}+pₚₐᵣₜ₋ₚₑₐₖ^{d}∥eₜ∥_{∞}^{part-peak}+pₚₑₐₖ^{d}∥eₜ∥_{∞}^{peak} (24)

In some instances Equation (21) above may not be directly used in determining the demand charge term because the MPC problem may be solved for a typically shorter time period than a utility bill—e.g., the MPC problem may be solved over a couple of days and the utility bill may be calculated over a month's time. To address this problem, previously observed energy consumption (e.g., ∥eₜ∥_{∞}^{τ}^{ₖ}) may be carried over into the global state variable sₜ^{G}, which is discussed further below and is an input variable to the demand charge function as indicated above. The previously observed energy consumption (e.g., ∥eₜ∥_{∞}^{τ}^{ₖ}) may be carried over into the global state variable as an accumulated energy consumption variable (sₜ^{GD}, referred to hereinafter as the demand charge state variable) of the global state variable sₜ^{G} and may be updated with each iteration of the MPC problem. For example, for a number “j” of previously calculated demand charge state variables sₜ^{GD}, the carryover into the global state variable sₜ^{G} may be represented by the following equation:

[s_{t,j}^{G}, . . . , s_{t, j+|I}_{^{d}}_{|}]=[s_{t,0}^{GD}, . . . , s_{t,|I}_{^{d}}_{|}^{GD}] (25)

In addition to Equation (25), the global state variable and associated demand charge variable may change over time as part of a global state change associated with the building 104, as indicated by the following equation:

sₜ₊₁^{GD}=fₜ^{GD}(sₜ^{G})=max{sₜ^{G}, e^{D}} (26)

The “max” operation of Equation (26) may be performed on an element-by-element basis and e^{D} may be determined using the following equation:

e^{D}=[∥eₜ∥_{∞}, ∥eₜ∥_{∞}^{τ}^{₁}, . . . , ∥eₜ∥_{∞}^{τ}^{_{|Id|}}] (27)

Accordingly, the demand charge state variable sₜ^{GD} may be part of the global state variable sₜ^{G}, may track prior energy consumption as recorded by the BEMS 102, and may change with time. In some instances the demand charge state variable sₜ^{GD} may be reset to a historically consistent value at the beginning of a billing cycle.

Using the above demand charge equations and their associated results, the demand charge D(p^{d}, eₜ, sₜ^{G}) may be calculated using the following equation:

$$\begin{matrix}D ( {p}^{d} , {e}_{t} , {s}_{t}^{G} ) = {{p}_{0}^{d} ( {‖ {e}_{t} ‖}_{∞} - {s}_{t , 0}^{GD} )}^{+} + {\sum }_{k ∈ {I}^{d} - \{ 0 \}} {{p}_{k}^{d} ( {‖ {e}_{t} ‖}_{∞}^{{τ}_{k}} - {s}_{t , k}^{GD} )}^{+} \\ + {{p}_{0}^{′ d} ( {‖ {e}_{t} ‖}_{∞} - {s}_{t , 0}^{GD} )}^{-} + {\sum }_{k ∈ {I}^{d} - \{ 0 \}} {{p}_{k}^{′ d} ( {‖ {e}_{t} ‖}_{∞}^{{τ}_{k}} - {s}_{t , k}^{GD} )}^{-}\end{matrix} \qquad ( 28 )$$

In Equation (28) “(x)⁻” (e.g., (∥eₜ∥_{∞}^{τ}^{ₖ}−s_{t,k}^{GD})⁻) may be equal to max {0, x}, “(x)⁻” (e.g., (∥eₜ∥_{∞}^{τ}^{ₖ}−s_{t,k}^{GD})⁻) may be equal to min{0, x}, and p′ₖ^{d} is a reward coefficient for reducing energy consumption during a peak demand period over previous times and may typically be less than an overall reward coefficient for reducing energy consumption pₖ^{d}. As such, Equation (28) may represent the running demand charge as the marginal effect of consumption on a predicted energy consumption projection while partially rewarding reduced energy consumption because although the reduced consumption may not help in the current billing cycle, if the reduced consumption is not exceeded in other billing cycles, the reduced consumption may be helpful for future bills. In some embodiments, p′ₖ^{d} may be tuned according to the energy usage patterns of the building 104. In these and other embodiments, p′ₖ^{d} may be set as one-half of pₖ^{d} as an initial starting point for p′ₖ^{d} before the energy consumption patterns of the building 104 may be determined.

The global state variable sₜ^{G} may include the demand charge state variable sₜ^{GD} as described above, and in some embodiments may also include a baseline state variable sₜ^{GBL} that may be used to model the effect of prior energy consumption as it may relate to different cost terms—e.g., a resource prioritization term described further below—as well as energy consumption by one or more of the systems 106. In some embodiments, the baseline state variable may be determined based on an average of prior energy consumption over a given amount of time. For example, the baseline state variable may be determined based on the average energy consumption over the previous ten days. Accordingly, in some embodiments, the global state variable sₜ^{G} may be expressed by the following equation:

sₜ^{G}=[sₜ^{GD}, sₜ^{GBL}] (29)

In Equation (29), sₜ^{GD} may be the demand charge state variable described above, and sₜ^{GBL} may be the baseline state variable. The baseline state variable sₜ^{GBL} may also change over time and in some embodiments the change may be expressed by the following equation:

sₜ₊₁^{GBL}=fₜ^{GBL}(sₜ^{GBL}) (30)

In Equation (30), fₜ^{GBL} may be an estimate of energy consumption by the building 104 as it relates to the baseline energy consumption of the building 104, as indicated by the baseline state variable sₜ^{GBL}. In some instances, sₜ^{GBL} may also be referred to as e^{BL}. In summary, the changes in the global state variable sₜ^{G} may be expressed by the following equation, which may also be reflected in Equation (3) above:

$${s}_{t + 1}^{G} = [ \begin{matrix}{s}_{t + 1}^{GD} \\ {s}_{t + 1}^{GBL}\end{matrix} ] = [ \begin{matrix}{f}_{t}^{GD} ( {s}_{t}^{GD} ) \\ {f}_{t}^{GBL} ( {s}_{t}^{GBL} )\end{matrix} ] = {f}_{t}^{G} ( {s}_{t}^{G} ) , \qquad ( 31 )$$

The demand response reward/penalty term R^{D}(eₜ, sₜ^{G}, eₜ^{UBL}, eₜ^{DR}) of Equation (1) may indicate the rewards or penalties that may be associated with a demand response and may depend on the type of demand response program that the building 104 may be subject to.

Demand response programs may include any suitable program that results in dynamic changes in energy consumption by a customer (e.g., the building 104). Demand response programs may have a variety of ranges and may include completely economic incentive-based programs such as dynamic pricing where the price of energy at an instant in time may vary similar to, and usually according to, wholesale energy prices. Another type of demand response program may include a Direct Load Control (DLC) program where a utility company may control certain systems (e.g., one or more of the systems 106) and may remotely turn off the certain systems if desired. Most demand response programs fall in between purely economic incentive programs and DLC programs by offering the energy to the consumer through a known and fixed, but potentially time varying, rate and then offering demand response programs to which interested users may subscribe. Such programs usually assign a reward for responding to the dynamic situation of the energy providing infrastructure (on top of their usual usage pattern). Under this category, there are typically two major types of demand response programs, Capacity Bidding Programs (CBP) and Demand Bidding Programs (DBP).

In a CBP, participants may be part of a monthly contract to participate in demand response events and may receive monthly payments for doing so. For example, for each event over that month, participants may be notified close to the actual event—typically day-ahead or day-of based on their choice of program—and get compensated for their response. In other words, there are multiple options for participation in CBP depending on how much in advance, with respect to the event time, the participants would like to be notified.

The CBP may also include minimum and maximum lengths of demand response events, sometimes referred to as “products.” Additionally, energy consumption changes by participants in CBPs may be performed via direct access by the corresponding utility (e.g., via a DLC program) or by the participants themselves, which may affect the rate structure. Moreover, participants in some CBPs may nominate the amount of energy consumption reduction that they may provide.

To summarize, participants in CBPs may choose a desired product and may nominate their desired amount of energy consumption reduction and may receive rewards and/or penalties based on compliance with their selection during a demand response event.

In a DBP, participants may not be subject to a prior energy consumption reduction commitment and may be notified of the demand response event close to the actual demand response event—typically day-ahead or day-of, like in a CBP, depending on the particular terms. Additionally, in DBPs the participants may be informed of a compensation rate for an upcoming demand response event when receiving notice of the upcoming demand response event and may respond with an amount of energy reduction that they are willing to implement during the demand response event. The participants may be compensated with energy payments based on the amount of reduction, and in some embodiments, with respect to how the amount of the reduction relates to the amount of reduction promised.

As mentioned above, the demand response reward/penalty term R^{D}(eₜ, sₜ^{G}, eₜ^{UBL}, eₜ^{DR}) and its associated form may depend on the type of demand response program that is associated with the building 104. However, the BEMS 102 may be configured to determine or know which demand response program is associated with the building 104 and may structure and generate the demand response reward/penalty term R^{D}(eₜ, sₜ^{G}, eₜ^{UBL}, eₜ^{DR}) accordingly.

In many demand response programs, performance of the response may be measured based on an hourly deliverance capacity ratio rₜ^{DR} , which may be expressed by the following equation:

$${r}_{t}^{DR} = \frac{{e}_{t}^{UBL} - {e}_{t}}{{e}_{t}^{DR}} \qquad ( 32 )$$

In equation (32), eₜ^{DR} may indicate the promised amount of energy reduction during the demand response event, eₜ^{UBL} may indicate the baseline energy consumption of the building 104, which may indicate normal energy consumption of the building 104, and eₜ may indicate the actual energy consumption trajectory of the building 104. Therefore, the delivered capacity ratio rₜ^{DR} may indicate how much of the promised energy reduction is actually delivered during the demand response event.

In some instances, the amount of compensation may be based on the value of the delivered capacity ratio rₜ^{DR}. In these and other instances, the compensation may be given if the delivered capacity ratio rₜ^{DR} is within upper and lower bounds as defined by the demand response program. For example, a demand response program may provide compensation only if the delivered capacity ratio rₜ^{DR} is greater than or equal to one-half and up to one and one-half In some cases, the performance measure may be averaged over the entire time interval of the demand response event.

In other cases, such as a non-averaged demand response performance measurement and a DBP, the demand response reward/penalty term R^{D}(eₜ, sₜ^{G}, eₜ^{UBL}, eₜ^{DR}) may be expressed by the following equation:

R^{D}(eₜ, sₜ^{G}, eₜ^{UBL}, eₜ^{DR})=pₜ^{EDR}eₜ^{DR}β^{DB}(rₜ^{DR}, a, b) (33)

In Equation (33), pₜ^{EDR} may represent a marginal energy reward for participation in the demand response event, eₜ^{DR} may indicate the promised amount of energy reduction during the demand response event, rₜ^{DR} may represent the delivered capacity ratio, a and b may represent the upper and lower bounds of the delivered capacity ratio rₜ^{DR}, and β^{DB}(rₜ^{DR}, a, b) may be an adjustment function that is based on rₜ^{DR}, a, and b and may be defined in some instances by the following equation:

$${β}^{DB} ( {r}_{t}^{DR} , a , b ) = \{ \begin{matrix}0 & {r}_{t}^{DR} < a , \\ {r}_{t}^{DR} & a \leq {r}_{t}^{DR} \leq b , \\ b & b < {r}_{t}^{DR}\end{matrix} \qquad ( 34 )$$

As mentioned above, for CBPs the demand response reward/penalty term R^{D}(eₜ, sₜ^{G}, eₜ^{UBL}, eₜ^{DR}) may be formulated differently. For example, for some CBPs, in addition to a marginal energy reward, a marginal capacity reward may also be generated, both of which may be prorated based on the delivered capacity ratio. In some embodiments, the demand response reward/penalty term R^{D}(eₜ, sₜ^{G}, eₜ^{UBL}, eₜ^{DR}) for the CBP may be expressed by the following equation:

R^{D}(eₜ, sₜ^{G}, eₜ^{UBL}, eₜ^{DR})=pₜ^{EDR}eₜ^{DR}β^{DB}(rₜ^{DR}, a, b)+pₜ^{CDR}β^{CB}(rₜ^{DR}, x, y). (35)

In Equation (35), pₜ^{EDR} may represent a marginal energy reward for participation in the demand response event, eₜ^{DR} may indicate the promised amount of energy reduction during the demand response event, rₜ^{DR} may represent the delivered capacity ratio, a and b may represent the upper and lower bounds, respectively, of the delivered capacity ratio rₜ^{DR} for the marginal energy reward, β^{DB}(rₜ^{DR}, a, b) may represent the adjustment function for the marginal energy reward that is based on rₜ^{DR}, a, and b, pₜ^{CDR} may represent the marginal capacity reward for participation in the demand response event, and, x, and y may represent the upper and lower bounds, respectively, of the delivered capacity ratio rₜ^{DR} for the marginal capacity reward, and β^{CB}(rₜ^{DR}, x, y) may represent the adjustment function for the marginal capacity reward.

The functions of Equations (33) and (35) for the demand response reward/penalty term R^{D}(eₜ, sₜ^{G}, eₜ^{UBL}, eₜ^{DR}) are merely examples and the demand response reward/penalty term R^{D}(eₜ, sₜ^{G}, eₜ^{UBL}, eₜ^{DR}) may be adjusted depending on specific parameters of the demand response program of which the building 104 may be enrolled. Additionally, in instances where the building 104 is not enrolled in a demand response program or no demand response event is scheduled during the time-frame of calculation by the BEMS 102, the marginal energy reward values may be set to zero such that the demand response reward/penalty term R^{D}(eₜ, sₜ^{G}, eₜ^{UBL}, eₜ^{DR}) may be zero and may not be used during the solving of the MPC problem.

The on-site electricity generation cost C^{GEN}(eₜ^{GEN}, sₜ^{G}, wₜ) of Equation (1) may be determined based on the energy consumption of the reliable generator systems eₜ^{GEN}, the global state variable sₜ^{G}, and exogenous factors wₜ that may affect energy generation and/or consumption by the intermittent generator systems. The energy consumption of the reliable generator systems may be determined using any suitable process or method including meters that may monitor the energy consumed (e.g., fuel used) by the reliable generator systems. The global state variable sₜ^{G} may be used to assess the amount of desired energy that may be generated by the generator systems in relation to the current state of the building 104. The exogenous factors may be determined based on any suitable acquisition method or process and may include factors such as amount of wind for a wind-powered generator system or amount of sunlight for a solar-powered generator system.

The resource prioritization term C^{PRI}(eₜ^{ML}, eₜ^{MEM}, eₜ^{BAT}, wₜ) of Equation (1) may be used by the MPC problem to discriminate between and prioritize the different systems 106 and their associated energy consumption. Therefore, systems 106 with higher importance may be prioritized higher than systems 106 with lower priorities in making decisions as to which systems 106 to control while reducing energy consumption.

In some embodiments, the resource prioritization term may assign smaller costs to higher priority systems 106 than to lower priority systems 106, such that the lower priority systems 106 may be adjusted (e.g., turned off) before the higher priority systems 106. The prioritization of the systems 106 may depend on particular goals, constraints, etc. associated with the building 104 such that they may vary depending on the use of the building 104. In some embodiments, the prioritization may be achieved by assigning negative numbers to the systems 106 in a manner that the negative number may reduce the amount of cost associated with the systems 106 as calculated by the MPC problem. Therefore, a higher priority system 106 may have a bigger negative number than a lower priority system 106 (e.g., −2 instead of −1) such that the cost of the higher priority system as determined by the MPC problem may be lower than the cost of the lower priority system as determined by the MPC problem.

For example, consider an embodiment where the building 104 includes a laptop, a main light, and accent lights as systems 106 that may be controlled by the BEMS 102 and indexed by integers. In this particular example, the resource prioritization term may be represented by the following equation:

$${C}^{PRI} ( {e}_{t}^{ML} , {e}_{t}^{MEM} ) = {\sum }_{t} {\sum }_{i ∈ R} {π}_{i} {e}_{t , i} \qquad ( 36 )$$

In Equation (36), R may be equal to {1, 2, 3} and πᵢ may indicate the prioritization for a particular system and may be less than 0 for all systems as indexed by “i.” Additionally, in this particular example, “1” may indicate the index for the laptop, “2” may indicate the index for the main light, and “3” may indicate the index for the accent lights. Moreover, in Equation (36) for this particular example, eₜ^{ML} indicate and include the energy consumption of the main light and the accent lights because they are memoryless systems and eₜ^{MEM} may indicate and include the energy consumption of the laptop because it is a system with memory.

In the particular example, the accent lights may have the lowest priority followed by the laptop such that the main light may have the highest priority such that the accent lights may be turned off before the laptop and the laptop may be turned off before the main light. Accordingly, the prioritization may follow the following equation:

π₂<π₁<π₃<0 (37)

Additionally, formulating the prioritization in the manner above may be such that in a demand response event if the compensation is not high enough, systems 106 with higher priorities (e.g., the main light) may not respond in reducing energy consumption during the demand response event. Further, in these or other embodiments, if either the compensation from a specific DR event is not high enough or the priority of many systems 106 are high, the optimization may suggest to “opt-out” of specific DR event completely. In other words, by comparing the cost, as indicated and adjusted by the prioritization, of participating in the specific DR event and not participating in the specific DR event, if the cost of not participating in the specific DR event is lower than participating in the specific DR event, then the MPC problem may indicate that the building 104 should “op-out” of the specific DR event

In some embodiments, the resource prioritization term may also be based on the states of systems with memory. Accordingly, the priority of the systems with memory may change or vary based on the state of the systems with memory. For example, in the laptop, accent lights, and main light example of above, the resource prioritization term may be expressed by the following equation:

$${C}^{PRI} ( {e}_{t}^{ML} , {e}_{t}^{MEM} , {s}_{t}^{MEM} ) = {\sum }_{t} ( {π}_{1} ( {s}_{t , 1} ) {e}_{t , i} + {π}_{2} {e}_{t , 2} + {π}_{3} {e}_{t , 3} ) . \qquad ( 38 )$$

In Equation (38), the priority coefficient of the laptop may depend on the state of the laptop (e.g., the state of charge of the battery of the laptop), which may allow the BEMS 102 to prioritize the laptop based on the state of its battery. For instance, in this particular example, the laptop may be prioritized if the state of the charge of its battery is below a certain level, which may be achieved in some embodiments by generating the following equation:

$${π}_{1} ( {s}_{t , 1} ) = \{ \begin{matrix}{π}_{1}^{h} & if & {s}_{t , 1} \leq {\tilde{s}}_{1} \\ {π}_{1}^{l} & if & {s}_{t , 1} > {\tilde{s}}_{1}\end{matrix} \qquad ( 39 )$$

Additionally, to account for the state of charge of the battery of the laptop, πᵢ may be selected based on the following equation:

π₂<π₁^{h}<π₃<π₁^{t}<0 (40)

Further based on principles explained in the above description, a general state dependent prioritization term may also be formed as indicated by the following equation:

$${C}^{PRI} ( {e}_{t}^{ML} , {e}_{t}^{MEM} , {s}_{t}^{MEM} , {w}_{t} , {s}_{t}^{G} ) = {\sum }_{t} {\sum }_{i ∈ R} {π}_{i} ( {s}_{t , i} , {w}_{t} , {s}_{t}^{G} ) {e}_{t , i} \qquad ( 41 )$$

In Equation (41), automatic priority changes may be made based on exogenous factors (e.g., weather) through dependence of πᵢ on ωₜ in a manner similar to the dependence of πᵢ on an associated state variable.

The above prioritization equations are given as mere examples and the scope of the present disclosure is not limited to such. For example, in some embodiments, non-linear functions may be used to set the prioritization for the systems 106 instead of the linear functions given as example equations.

Equation (1) above may also be subject to a variety of constraints and dynamics as indicated by Equations 2-20 above. For example, as indicated above, the systems 106 may include memoryless systems, systems with memory, HVAC systems, battery systems and generator systems, which may affect the modeling of the MPC problem. The interaction of these different systems with the MPC problem is discussed below.

As described above, memoryless systems may be systems 106 whose current energy consumption may not be affected by prior energy consumption. Therefore, the memoryless systems may not have a state or associated state variable that indicates their past behavior. An example of a memoryless system is a light system. The control variables for the memoryless systems uₜ^{ML} may be continuous or discrete depending on the memoryless systems. For example, a light system may be controlled in a discrete on/off manner or may be controlled in a more continuous type manner such as through a dimmer system.

Memoryless systems may be modeled with a function that may map their control input and any associated exogenous factors with the amount of energy consumed by the memoryless systems. For example, Equations (5) and (6) above may be used to model the memoryless systems and are repeated below as Equations (42) and (43), respectively.

eₜ^{ML}=gₜ^{ML}(uₜ^{ML}, wₜ) (42)

uₜ^{ML} ∈ Uₜ^{ML}(wₜ) (43)

In some instances, Equations (42) and (43) may be modeled as vectors that include energy consumption and control variables for each of the memoryless systems of the building 104. For example, Equations (42) and (43) may be modeled as vectors for different memoryless systems such as an elevator system, an accent light system, a landscape fountain, flat-screen televisions, and different light zones that may be included in the building 104.

In contrast to memoryless systems, systems with memory may have current energy consumption that depends on their past state or energy consumption, as described above. The memory may be due to a physical energy storing capacity of the systems. For example, heating/cooling appliances such as coffee machines, refrigerated vending machines, and refrigerators may be systems with memory. The MPC problem may model the memory of the systems with memory with the state variable sₜ^{MEM}, which in some instances may be a vector that may include the states of all the systems with memory. The state variable sₜ^{MEM} may include the variables on which the current energy consumption and states of the systems with memory may depend. For example, the state variable sₜ^{MEM} may include a state variable for a refrigerator that may include the inside temperature of the refrigerator.

The dynamics of each of the systems with memory may be modeled in some embodiments based on Equations (7) and (8) above, which are repeated as Equations (44) and (45), respectively, below:

sₜ₊₁^{MEM}=fₜ^{MEM}(uₜ^{MEM}, sₜ^{MEM}, sₜ^{G}, wₜ) (44)

eₜ^{MEM}=gₜ^{MEM}(uₜ^{MEM}, sₜ^{MEM}, sₜ^{G}, wₜ). (45)

Other examples of systems with memory may include plug-in electric vehicle systems where the associated state variable may include the remaining amount of energy (e.g., battery capacity minus the state of charge) that may be used by the plug-in electric vehicle system. For the plug-in electric vehicle systems, fₜ^{MEM} may model the accumulation of energy in the associated batteries and gₜ^{MEM} may model the amount of energy that may be used to charge the batteries to capacity from the current accumulation state.

Some systems with memory may be systems that have a set amount of time that they may be run, but that may also have a flexible run time, such as a washing machine that may have a certain cycle time, but the cycle may be interrupted. Such systems may be considered systems with memory because where the systems are in a particular cycle may indicate how much more energy the systems may consume. Accordingly, the BEMS 102 may be configured to track the status, run-time so far, time elapsed since last run-time, run-time remaining, etc. for some types of systems with memory.

The HVAC system of the building 104 may also be modeled by the MPC problem. In some instances, even though the HVAC system may be considered a system with memory, the HVAC system may be modeled separate from other systems with memory because the HVAC system may have a high importance in improving energy efficiency and may be relatively complex as compared to other systems with memory. However, in other instances the HVAC system may be modeled with the other systems with memory.

The HVAC system model may include one or more state variables associated with the HVAC system such as current temperature and/or humidity levels. The selection of state variables may vary depending on the use of the building 104 and may be determined based on which state variables may indicate the most accurate input and output relationship with respect to control settings and energy consumption output.

By way of example, consider an HVAC system in which the state variables may be specified by zone temperatures of the building 104. Additionally, the control settings may be specified by the set-points of thermostats that may control the temperatures of the zones. The thermostats may have both a heating set-point and cooling set-point in some instances, and in other instances may have a single set-point for both heating and cooling. In the present example, the HVAC system may be modeled in the MPC problem by the following equations in vector form:

$$\begin{matrix}\begin{matrix}{s}_{t + 1}^{HVAC} = {f}_{t}^{HVAC} ( {u}_{t}^{HVAC} , {s}_{t}^{HVAC} , {s}_{t}^{G} , {w}_{t} ) \\ = {A}^{HVAC} {s}_{t}^{HVAC} + {B}^{HVAC} {u}_{t}^{HVAC} + {E}^{HVAC} {s}_{t}^{G} + {G}^{HVAC} {w}_{t} ,\end{matrix} & ( 46 ) \\ \begin{matrix}{e}_{t}^{HVAC} = {g}_{t}^{HVAC} ( {u}_{t}^{HVAC} , {s}_{t}^{HVAC} , {s}_{t}^{G} , {w}_{t} ) \\ = {C}^{HVAC} {s}_{t}^{HVAC} + {D}^{HVAC} {u}_{t}^{HVAC} + {F}^{HVAC} {s}_{t}^{G} + {H}^{HVAC} {w}_{t}\end{matrix} & ( 47 )\end{matrix}$$

such that:

sₜ^{HVAC}≦sₜ^{HVAC}≦sₜ^{-HVAC}, (48)

uₜ^{HVAC}≦uₜ^{HVAC}≦uₜ^{-HVAC}, (49)

In Equations (46) and (47) the terms A^{HVAC}, B^{HVAC}, C^{HVAC}, D^{HVAC}; E^{HVAC}, F^{HVAC}, G^{HVAC}, and H^{HVAC}, may indicate model parameters of the HVAC system model. A^{HVAC} may indicate the contribution of the impact of a previous state of the HVAC system (e.g., previous temperature) on a future value of the state such that it may model the memory of the HVAC system. B^{HVAC} may describe the effect of a control setting on the state—e.g., the effect of a temperature set-point on the temperature of a zone. C^{HVAC} may indicate the effect of the state on energy consumption of the HVAC system. D^{HVAC} may indicate the effect of the control setting on the energy consumption of the HVAC system. E^{HVAC} may indicate the effect of a global state associated with the building 104 as it may relate to future states of the HVAC system. F^{HVAC} may indicate the effect of the global state on the energy consumption of the HVAC system. G^{HVAC} may indicate the effect of exogenous factors on the states of the HVAC system and H^{HVAC} may indicate the effect of the exogenous factors on energy consumption of the HVAC system.

The above terms A^{HVAC}, B^{HVAC}, C^{HVAC}, D^{HVAC}; E^{HVAC}, F^{HVAC}, G^{HVAC}, and H^{HVAC} may be matrices that include a value for each of the zones of the building 104 in instances when the building 104 may include multiple zones controlled by the HVAC system. The terms and associated HVAC model for the zones may be derived through physical modeling of the HVAC system or automatic identification techniques. Additionally, the parameters in Equations (48) and (49) may indicate allowable temperature and temperature set point ranges, respectively, for the zones of the building 104. The allowable temperature and temperature set point ranges may vary from zone to zone.

Accordingly, the MPC problem may include a model of the HVAC system as described above. The above-described model and associated equations are given merely as examples and other models and equations may be used depending on specific implementations.

In some embodiments, the building 104 may also include a battery system that may be modeled by the MPC problem. The battery system may also be considered a system with memory, but may have a distinctive feature in that the battery system may provide energy as well as use energy. To capture this ability of the battery system, the battery system may be modeled using the following equations in some instances:

$$\begin{matrix}\begin{matrix}{s}_{t + 1}^{BAT} = {f}_{t}^{BAT} ( {u}_{t}^{BAT} , {s}_{t}^{BAT} , {w}_{t} ) \\ = {s}_{t}^{BAT} + [ {{η}_{IN}^{BAT} ( {u}_{t}^{BAT} )}^{+} + {{η}_{OUT}^{BAT} ( {u}_{t}^{BAT} )}^{-} ] Δ t ,\end{matrix} & ( 50 ) \\ \begin{matrix}{e}_{t}^{BAT} = {g}_{t}^{BAT} ( {u}_{t}^{BAT} , {s}_{t}^{BAT} , {w}_{t} ) \\ = {u}_{t}^{BAT} .\end{matrix} & ( 51 )\end{matrix}$$

Additionally, the dynamics of Equations (50) and (51) may be subject to the constraints as expressed by the following equations:

sₜ^{BAT}≦sₜ^{BAT}≦sₜ^{-BAT}, (52)

uₜ^{BAT}≦uₜ^{BAT}≦uₜ^{-BAT}, (53)

In Equation (52), sₜ^{BAT} may be the low state of charge limits of the battery system, and sₜ^{-BAT} may be the high state of charge limit of the battery system. In Equation (53), uₜ^{BAT} may indicate the maximum amount of energy output by the battery system and uₜ^{-BAT} may indicate the maximum amount of energy that may be input to the battery system.

The battery system may have a limited life such that the battery system may need to be replaced after a certain amount of time or a certain number of cycles. Accordingly, in some embodiments, the battery system model of the MPC problem may include a per-stage cost associated with the battery system that may capture the costs associated with running the battery system including cycling costs and aging. The exact form of the model may vary significantly depending on which battery technology may be used by the battery system.

Accordingly, the MPC problem may include a model of a battery system as described above. The above-described battery model and associated equations are given merely as examples and other models and equations may be used depending on specific implementations.

The generator systems that may be included in the MPC problem may affect the on-site electricity generation cost as indicated above. In some embodiments, the cost of running a generator system may at least partially offset the cost of purchasing electricity. Accordingly, the use of the generator system may be used by the MPC problem while determining the cost function and system constraints. The generator systems may include reliable generator systems (e.g., generator systems driven by fuel) that may be completely controlled by the BEMS 102 and may also include intermittent generator systems that may rely on exogenous factors such as wind or solar generator systems. The MPC problem may include in the calculations the use of reliable generator systems as well as current and predicted exogenous factors that may affect energy generation by intermittent generator systems in determining the overall cost and controls.

For example, in some embodiments, a demand response event may not be met by the building 104 strictly reducing its energy consumption. However, the building 104 may comply with the demand response in relation to the amount of energy received from the associated utility company by generating some of its needed energy using a generator system. The MPC problem may take into consideration the cost of this energy generation as well as savings with respect to the demand response event to indicate whether or not this is an advisable course of action.

The BEMS 102 may be configured to solve the above-described MPC problem to determine settings for one or more of the systems 106 to achieve a desired energy consumption and cost associated with the building 104. As described above, the MPC problem may consider the dynamic nature of the energy consumption of the building 104 to allow for improved energy consumption and reduced cost associated with the building 104. Additionally, in some embodiments, when a demand response event is indicated, the BEMS 102 may solve the above-described MPC problem based on participating in the demand response event and based on not participating in the demand response event. The MPC problem may accordingly indicate whether or not participation in the demand response is cost effective.

Modifications may be made to the system 100 and/or the foregoing discussion without departing from the scope of the present disclosure. For example, as mentioned above, changes may be made to the equations and parameters described above with respect to the MPC problem described above. Additionally, one or more of the parameters or equations of the MPC problem may be omitted depending on a particular implementation. For example, some models may not be applicable to a particular building when the particular building does not have an associated system and may be omitted from the MPC problem—e.g., the particular building may not have a battery system such that the MPC problem may omit an associated battery system model.

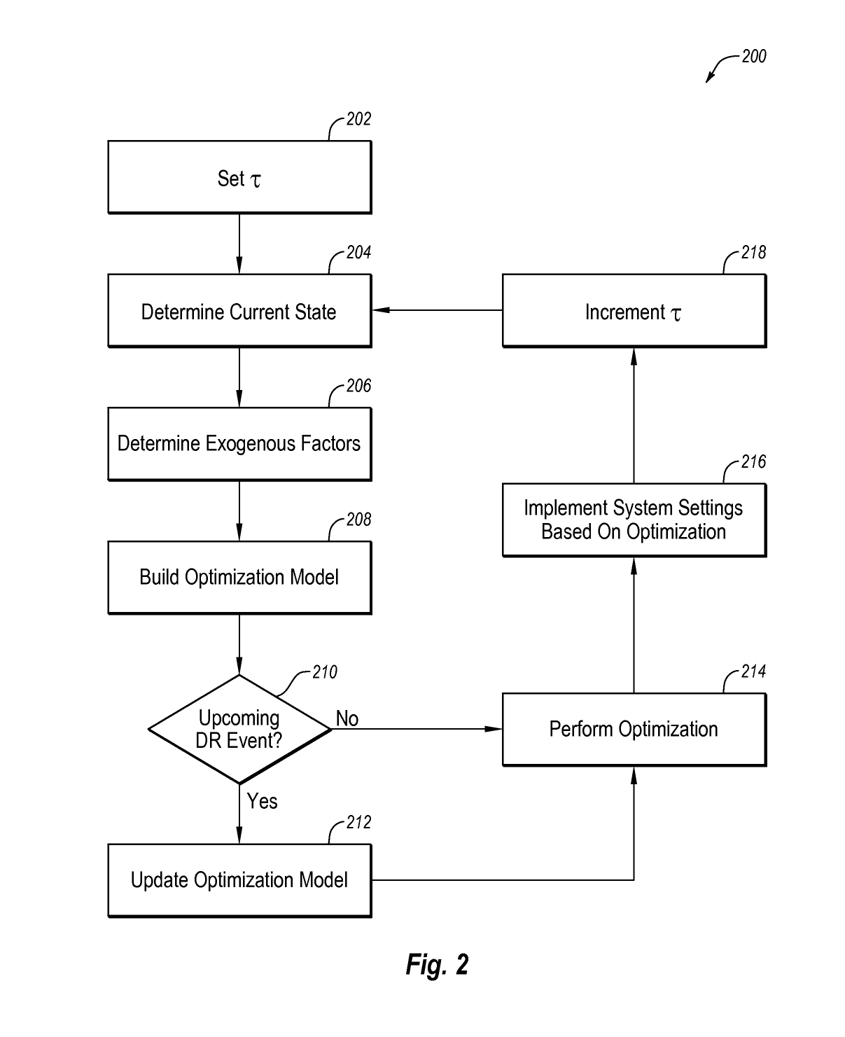

FIG. 2 is a flowchart of an example method 200 of building energy management optimization that may be performed by the BEMS 102 of FIG. 1, arranged in accordance with at least one embodiment described herein. The method 200 may be used by the BEMS 102 to determine and execute settings for the systems 106 of the building 104 to improve energy efficiency and cost savings for the building 104. Although illustrated as discrete blocks, various blocks may be divided into additional blocks, combined into fewer blocks, or eliminated, depending on the desired implementation.

The method 200 may begin and at block 202 a time index “τ” may be set. In some embodiments and as mentioned above, the BEMS 102 may perform the method 200 repetitively over time such that the BEMS 102 may dynamically adjust the settings for the systems 106 based on changes in various conditions such as changes in exogenous factors. The time index “τ” may accordingly be set to track the iterations that may be performed with respect to method 200 and may indicate an amount of time that may pass between performing the iterations.

At block 204, a current state associated with energy consumption of a building may be determined. As mentioned above, the current state associated with energy consumption of the building may include current energy consumption of systems of the building, past energy consumption of systems with memory, individual states of the systems with memory (e.g., temperatures controlled by certain systems, battery charge level of a battery system, etc.), and the like.

At block 206, exogenous factors that may affect the energy consumption and/or energy generation of the systems may also be determined. As mentioned above, some exogenous factors may include, but are not limited to, weather conditions, occupancy of the associated building, use of electrical outlets, on-site renewable energy generation (e.g., solar, wind), etc. The determined exogenous factors may include current exogenous factors and/or future exogenous factors predicted for a certain amount of time.

At block 208, an optimization model may be built based on the current state and exogenous factors determined at blocks 204 and 206. The optimization model may be configured based on an energy and cost optimization of the building. The optimization model may also be based on a learning process previously performed during conditions similar to the current state and the exogenous factors to predict energy consumption of the building. In some embodiments, the optimization model may be built as an MPC problem, such as the MPC problem discussed in detail above.

At block 210, it may be determined whether or not there is an upcoming DR event. If there is an upcoming DR event (“Yes” at block 210), the optimization model may be updated at block 212 to account for the DR event and the method 200 may proceed to block 214. If there is not an upcoming DR event (“No” at block 210), the method 200 may proceed from block 210 to block 214.

At block 214, optimization may be performed to determine settings for the systems of the building that may achieve a desired energy consumption projection and related cost associated with the building. In some embodiments, the optimization may be performed by solving the MPC problem generated at block 208.

At block 216, settings of systems of the building may be implemented based on the optimization determined at block 214 to direct energy consumption of the building according to the desired energy consumption projection. At block 218, the time index “τ” may be incremented and the method 200 may return to block 204 to determine the current state again. In some embodiments, the method 200 may wait a predetermined amount of time as indicated by the time index “τ” before returning to block 204.

Accordingly, the method 200 may be used for building energy management optimization. The use of the method 200 may allow for dynamic analysis and changes to the energy consumption of the building to allow for a more accurate and improved optimization over current optimization schemes.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

As indicated above, the embodiments described herein may include the use of a special purpose or general purpose computer (e.g., the processor 108 of FIG. 1) including various computer hardware or software modules, as discussed in greater detail below.

Further, as indicated above, embodiments described herein may be implemented using computer-readable media (e.g., the memory 110 of FIG. 1) for carrying or having computer-executable instructions or data structures stored thereon. Such computer-readable media may be any available media that may be accessed by a general purpose or special purpose computer. By way of example, and not limitation, such computer-readable media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data which cause a general purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method of managing energy consumption of a building, the method comprising:
determining a current state associated with energy consumption of a building;
determining exogenous factors that relate to energy consumption of the building;
performing an energy consumption and cost optimization based on the current state, the exogenous factors, and an energy consumption rate structure to generate a desired energy consumption projection for the building over a period of time; and
controlling one or more systems of the building to direct energy consumption of the building according to the desired energy consumption projection.

2. The method of claim 1, wherein the current state associated with energy consumption of the building includes one or more of: current energy consumption of the one or more systems, past energy consumption of one or more of the one or more systems, and individual states of the one or more systems.

3. The method of claim 2, wherein the individual states include one or more of temperatures controlled by the one or more systems, battery charge level, and whether the one or more systems are on or off.

4. The method of claim 1, wherein the exogenous factors include one or more of: weather conditions, occupancy of the building, use of electrical outlets of the building, and renewable energy generation at the building.

5. The method of claim 1, wherein the exogenous factors include one or more of current exogenous factors and predicted exogenous factors.

6. The method of claim 1, wherein performing the energy consumption and cost optimization is further based on a demand response event.

7. The method of claim 1, wherein performing the optimization includes generating and solving a model predictive control problem.

8. The method of claim 1, further comprising determining whether or not to participate in a demand response event based on the energy consumption and cost optimization.

9. The method of claim 1, further comprising:
categorizing the one or more systems according to one or more of the following categories: a system with memory, a memoryless system, a heating and air-conditioning system, a generator system, and a battery system; and
performing the optimization based on the categorization.

10. The method of claim 1, further comprising:
prioritizing the one or more systems according to importance; and
performing the optimization based on the prioritization.

11. A system of managing energy consumption of a building, the system comprising:
a processor; and
a non-transitory computer-readable medium communicatively coupled to the processor and having instructions stored thereon that are executable by the processor to perform operations comprising:
determining a current state associated with energy consumption of a building;
determining exogenous factors that relate to energy consumption of the building;
performing an energy consumption and cost optimization based on the current state, the exogenous factors, and an energy consumption rate structure to generate a desired energy consumption projection for the building over a period of time; and
controlling the one or more systems of the building to direct energy consumption of the building according to the desired energy consumption projection.

12. The system of claim 11, wherein the current state associated with energy consumption of the building includes one or more of: current energy consumption of the one or more systems, past energy consumption of one or more of the one or more systems, and individual states of the one or more systems.

13. The system of claim 12, wherein the individual states include one or more of temperatures controlled by the one or more systems, battery charge level, and whether the one or more systems are on or off.

14. The system of claim 11, wherein the exogenous factors include one or more of: weather conditions, occupancy of the building, use of electrical outlets of the building, and renewable energy generation at the building.

15. The system of claim 11, wherein the exogenous factors include one or more of current exogenous factors and predicted exogenous factors.

16. The system of claim 11, wherein performing the energy consumption and cost optimization is further based on a demand response event.

17. The system of claim 11, wherein performing the optimization includes generating and solving a model predictive control problem.

18. The system of claim 11, wherein the operations further comprise determining whether or not to participate in a demand response event based on the energy consumption and cost optimization.

19. The system of claim 11, wherein the operations further comprise:
categorizing the one or more systems according to one or more of the following categories: a system with memory, a memoryless system, a heating and air-conditioning system, a generator system, and a battery system; and
performing the optimization based on the categorization.

20. The system of claim 11, wherein the operations further comprise:
prioritizing the one or more systems according to importance; and
performing the optimization based on the prioritization.
